(19) United States
(12) Patent Application Publication
(10) Pub. No.: US 2005/0147024 A1
(43) Pub. Date: Jul. 7, 2005

(54) Communication method in an FH-OFDM cellular system

(75) Inventors: Young-Ho Jung, Haeundae-gu (KR); Eung-Sun Kim, Suwon-si (KR); Jong-Hyeuk Lee, Seongnam-si (KR); Jae-Hak Chung, Seoul (KR); Chan-Soo Hwang, Yongin-si (KR); Seung-Hoon Nam, Seoul (KR); Yong-Hoon Lee, Yuseong-gu (KR); Young-Doo Kim, Seoul (KR)

Correspondence Address: DILWORTH & BARRESE, LLP, 333 EARLE OVINGTON BLVD., UNIONDALE, NY, 11553, US

(73) Assignees: SAMSUNG ELECTRONICS CO., LTD, GYEONGGI-DO (KR); KOREA ADVANCED INSTITUTE OF SCIENCE AND TECHNOLOGY, DAEJON (KR)

(21) Appl. No.: 10/972,034

(22) Filed: Oct. 22, 2004

(30) Foreign Application Priority Data
Oct. 29, 2003 (KR) 2003-75841

(51) Int. Cl. H04J 11/00

(52) U.S. Cl. 370/203

(57) ABSTRACT

A communication method in an FH-OFDM communication system having a plurality of BSs is provided. A predetermined number of pilot pattern groups are generated, each pilot pattern group having a predetermined number of different pilot patterns for pilot transmission. The pilot patterns in each of the pilot pattern groups are mapped to different FH sequence sets. The pilot patterns and FH sequence sets are assigned to the BSs so that MSs within the service areas of the BSs can identify the BSs.

### PRIORITY

This application claims priority under 35 U.S.C. § 119 to an application entitled “Communication Method in an FH-OFDM Cellular System” filed in the Korean Intellectual Property Office on Oct. 29, 2003 and assigned Serial No. 2003-75841, the contents of which are incorporated herein by reference.

### BACKGROUND OF THE INVENTION

1. Field of the Invention

The present invention relates generally to a frequency hopping (FH)-orthogonal frequency division multiplexing (OFDM) communication system, and in particular, to a method of identifying a base station (BS) by its pilot pattern and acquiring an initial synchronization to the BS.

2. Description of the Related Art

Conventionally, a cellular mobile communication system divides its service area into smaller service areas, i.e., smaller cells covered by BSs in the service area. A mobile switching center (MSC) controls these BSs such that mobile stations (MSs) can continue ongoing calls, when moving from one cell to another. In the cellular system, to initiate a communication with a BS at an initial power-on, an MS must obtain the characteristics of the BS to which the MS currently belongs. The BS characteristics include a frequency at which the MS accesses and synchronization information.

OFDM is a communication scheme in which input data is transmitted in parallel at low rate on a plurality of carriers rather than at high rate on a single carrier. OFDM reduces effects of frequency-selective fading or narrowband interference. The spectrums of sub-channels are orthogonal, overlapped with one another, resulting in good spectral efficiency. Because a transmission signal is modulated by IFFT (Inverse Fast Fourier Transform) and a received signal is demodulated by FFT (Fast Fourier Transform), a digital modulator/demodulator can be used efficiently. A major benefit from this structure is that a receiver can be implemented using a one-tap equalizer requiring only one complex multiplication step per carrier.

OFDM is currently under consideration to be adopted as a physical layer transmission scheme for post-3^{rd} generation mobile communication systems due to the advantage of its ability of high-speed transmission with low equalization complexity on a frequency-selective fading channel. Initial downlink synchronization includes frequency offset estimation, OFDM symbol synchronization, BS identification, and frame synchronization in the OFDM communication system.

In order to roam within the entire service area of the cellular system and still be able to communicate, an MS needs a sufficient number of BS IDs (Identifications) and must search for the ID of a BS of interest with a low complexity and a high search probability. Typically, the OFDM system transmits a pilot signal at every interval within a coherence bandwidth, for channel estimation. The MS identifies a BS by detecting the position of the pilot signal.

FH-OFDM, which is one of multiple access schemes in the OFDM system, performs frequency hopping at a sub-carrier level. An FH-OFDM BS dynamically assigns sub-carriers to each symbol according to an FH sequence set, which is specific to the BS, thus achieving a frequency diversity gain and reducing inter-cell interference. The FH sequence set contains FH sequences that are orthogonal to each other. Neighbor BSs can use orthogonal sub-carriers simultaneously without inter-cell interference. The MS identifies different FH sequence sets for different BSs by detecting the positions of pilot samples at a sub-carrier level.

FIG. 1 illustrates the structure of an OFDM frame in a conventional FH-OFDM communication system. A vertical axis represents sub-carriers and a horizontal axis represents symbol time in a matrix-shaped OFDM frame. Each column forms one OFDM symbol and each block is a data sample.

Referring to FIG. 1, to avoid the situation in which neighbor BSs use the same sub-carriers simultaneously, a different Latin square pilot pattern slope is assigned to each BS. In the illustrated case, the slope representing the ratio of a sub-carrier variation to a symbol time variation is 4 and the position of a sub-carrier that delivers a pilot sample in the first symbol time is a frequency offset.

In the conventional technology, sub-carriers that deliver pilots change over time according to a pilot pattern. There is no intra-cell interference for the pilot signal and using pilot patterns having different slopes in neighbor cells results in an inter-cell interference averaging effect.

The MS estimates the frequency offset and acquires symbol synchronization based on the cyclicity of a Cyclic Prefix (CP) inserted for every OFDM symbol. Further, the MS directly estimates the pilot pattern slope and a time offset using pilot symbols in variable positions according to the FH sequence set of the BS. The estimation of the pilot pattern slope is equivalent to identifying the FH sequence set, and the time offset estimation acquires synchronization information about the BS.

While as many BS IDs as the number of sub-carriers can be obtained and there is no need for a particular physical channel for BS identification due to transmission of pilot samples in each OFDM symbol, the conventional technology is viable only when the Latin square FH sequences are used. Further, a large-capacity buffer and a large volume of much computation are required to estimate the pilot pattern slope and the offsets from the OFDM frame having both pilot samples and data samples.

The MS must identify BSs when it searches neighbor BSs for a handoff as well as when it is powered-on and initially searches for a BS to service it. After the MS compensates for the frequency offsets of the neighbor BSs and performs FFT on each OFDM symbol, the MS carries out a BS search to directly estimate the slopes of Latin square FH sequences and offsets of neighbor BSs. Therefore, the MS stops communication with the serving BS for a short time. As a result, transmission capacity is decreased.

Additionally, known symbols are inserted as a preamble at the start of an OFDM frame and the MS estimates the start point of the OFDM frame by detecting the preamble in the OFDM system.

FIG. 2 illustrates an OFDM frame including a preamble in a conventional OFDM communication system. Referring to FIG. 2, the preamble includes special symbols attached as a prefix to the OFDM frame. In general, the structure and contents of the preamble are known to both a transmitter and a receiver. The preamble is configured to achieve a maximum performance of synchronization and channel estimation with a relatively low complexity.

The requirements for a good preamble structure are excellent compensation capability for time synchronization, low PAPR (Peak to Average Power Ratio) for high-power transmission, appropriate channel estimation capability, frequency offset estimation capability over a wide range, low computation complexity, low overhead, and high accuracy. However, it is not easy to design such a preamble structure that satisfies most of the above requirements in the FH-OFDM communication system.

Commonly, existing initial synchronization techniques in the FH-OFDM communication system encounter the following problems.

1. Only Latin square FH sequences are available for identification of BSs in the FH-OFDM system.

2. A large volume of computation is required to achieve optimum detection performance when a Latin square FH sequence slope and an offset are used as BS identification and synchronization information.

3. Because a frequency-domain received signal is utilized in the conventional technology, communication between an MS and a serving BS is inevitably interrupted to identify a neighbor BS and acquire synchronization information from the neighbor BS at a handoff.

### SUMMARY OF THE INVENTION

Therefore, an object of the present invention is to substantially solve at least the above problems and/or disadvantages and to provide at least the advantages below. Accordingly, an object of the present invention is to provide an initial synchronization method for initiating a downlink communication in an FH-OFDM communication system.

Another object of the present invention is to provide a BS identifying method and an initial synchronization method using the same in an FH-OFDM communication system.

A further object of the present invention is to provide a method of acquiring an FH sequence and synchronization information of a BS that will provide a service by identifying a pilot pattern group and a pilot pattern for identifying the BS and detecting the start point of a frame.

Still another object of the present invention is to provide a method of generating a preamble representing a start point of an OFDM frame, for initial synchronization in an FH-OFDM communication system.

The above and other objects are achieved by providing a communication method in an FH-OFDM communication system. In a communication method in an FH-OFDM communication system including a plurality of BSs, a predetermined number of pilot pattern groups are generated, each pilot pattern group having a predetermined number of different pilot patterns for pilot transmission. The pilot patterns in each of the pilot pattern groups are mapped to different FH sequence sets. The pilot patterns and FH sequence sets are assigned to the BSs so that MSs within the service areas of the BSs can identify the BSs.

In an access method in an FH-OFDM communication system including a plurality of BSs, an MS receives a plurality of symbols from a BS, each having pilot samples, detects sub-carriers that deliver the pilot samples in each of the symbols, and identifies a pilot pattern group corresponding to the pilot sub-carriers. The MS detects a pattern of the pilot samples and estimating an FH sequence set corresponding to the pilot pattern to receive data from the BS.

### BRIEF DESCRIPTION OF THE DRAWINGS

The above and other objects, features, and advantages of the present invention will become more apparent from the following detailed description when taken in conjunction with the accompanying drawings in which:

FIG. 1 illustrates an OFDM frame in a conventional FH-OFDM communication system;

FIG. 2 illustrates an OFDM frame including a preamble in a typical OFDM communication system;

FIG. 3 is a flowchart illustrating an operation for assigning pilot patterns to BSs according to a preferred embodiment of the present invention;

FIG. 4 illustrates an embodiment of a pilot pattern group design according to the present invention;

FIG. 5 illustrates an embodiment of a pilot pattern group reuse according to the present invention;

FIG. 6 illustrates an embodiment of a pilot pattern design using Hadamard sequences according to the present invention;

FIG. 7 is a block diagram of a BS transmitter in an FH-OFDM system to which the present invention is applied;

FIG. 8 is a flowchart illustrating an operation in an MS for acquiring initial synchronization to a BS according to a preferred embodiment of the present invention;

FIG. 9 is a block diagram of an MS receiver in correspondence with the transmitter illustrated in FIG. 6 in the FH-OFDM system to which the present invention is applied;

FIG. 10 illustrates an OFDM frame including a time-domain preamble according to the present invention;

FIG. 11 illustrates an embodiment of assignment of pilot pattern groups and pilot patterns according to the present invention;

FIG. 12 is a graph comparing the present invention with a conventional optimal estimation algorithm using Latin square FH sequences in terms of detection errors versus a ratio of bit energy to noise (E_{b}/Nₒ);

FIG. 13 is a graph comparing the present invention with the conventional optimal estimation algorithm using Latin square FH sequences in terms of detection errors versus normalized Doppler frequency (f_{D}T_{S}) for varying Nₛ; and

FIG. 14 is a table comparing the present invention with the conventional optimal estimation algorithm using Latin square FH sequences in terms of computation requirements.

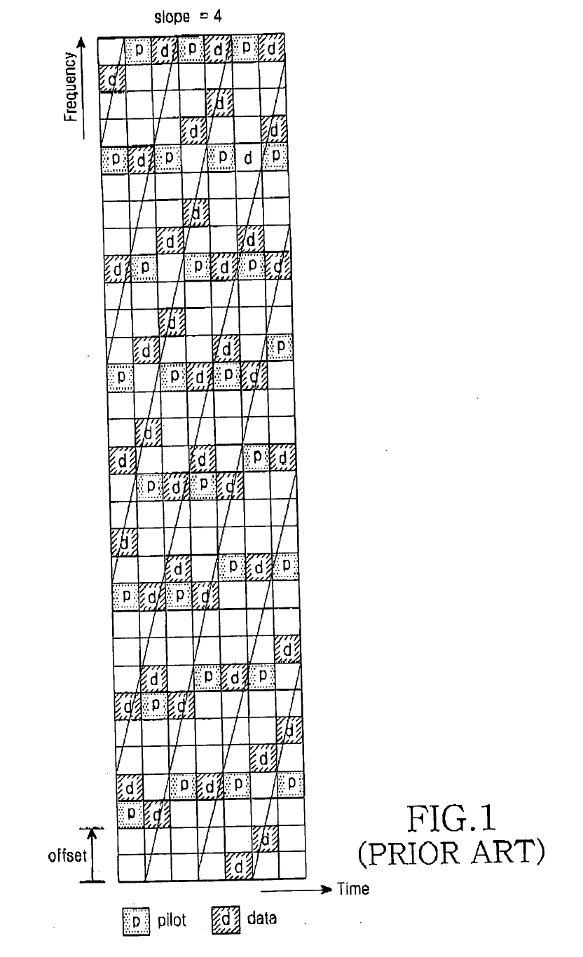

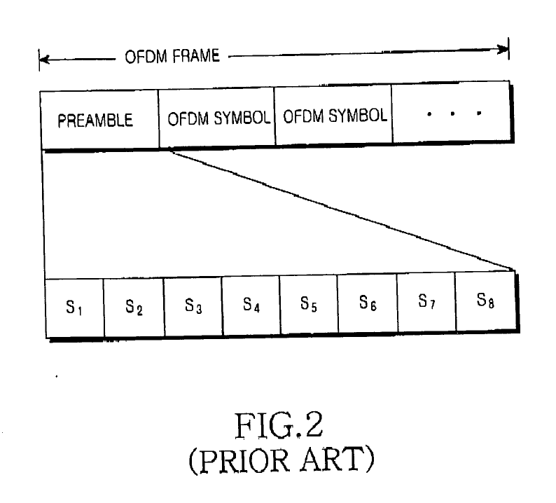

### DETAILED DESCRIPTION OF THE PREFERRED EMBODIMENTS

Preferred embodiment of the present invention will now be described in detail herein below with reference to the accompanying drawings. In the following description, well-known functions or constructions are not described in detail since they would obscure the invention in unnecessary detail.

The following description of the present invention is divided into a description of a method for identifying a BS using a pilot pattern group and a pilot pattern, and a description of a method of generating a preamble for time-domain frame synchronization.

Identifying of BS

An FH-OFDM system assigns different pilot patterns to different BSs in order to distinguish FH sequences used in the BSs. Because the pilot pattern of a BS corresponds to the FH sequence specific to the BS, an MS determines the FH sequence by identifying the pilot pattern. A system designer assigns pilot patterns when designing cells or modifying a cell structure due to an addition or a removal of a BS.

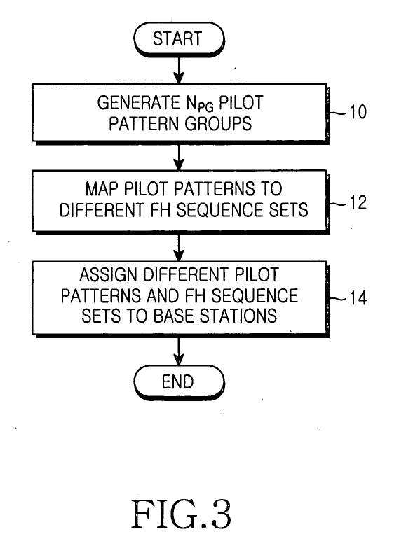

FIG. 3 is a flowchart illustrating an operation for assigning pilot patterns to BSs according to a preferred embodiment of the present invention. Referring to FIG. 3, N_{PG} pilot pattern groups are generated in step 10. The pilot pattern groups differ in pilot position and each pilot pattern group includes N_{PP} pilot patterns with pilots in the same positions. In step 12, different FH sequence sets are mapped to the pilot patterns of each pilot pattern group. A total of (N_{PG}×N_{PP}) pilot patterns are assigned to BSs in step 14. Assuming that the number (N) of sub-carriers is 128 and the number (N_{P}) of sub-carriers that deliver pilots (hereinafter, referred to as pilot sub-carriers) is 16, N_{PG} is 8. Therefore, the BSs have different pilot patterns and corresponding FH sequences.

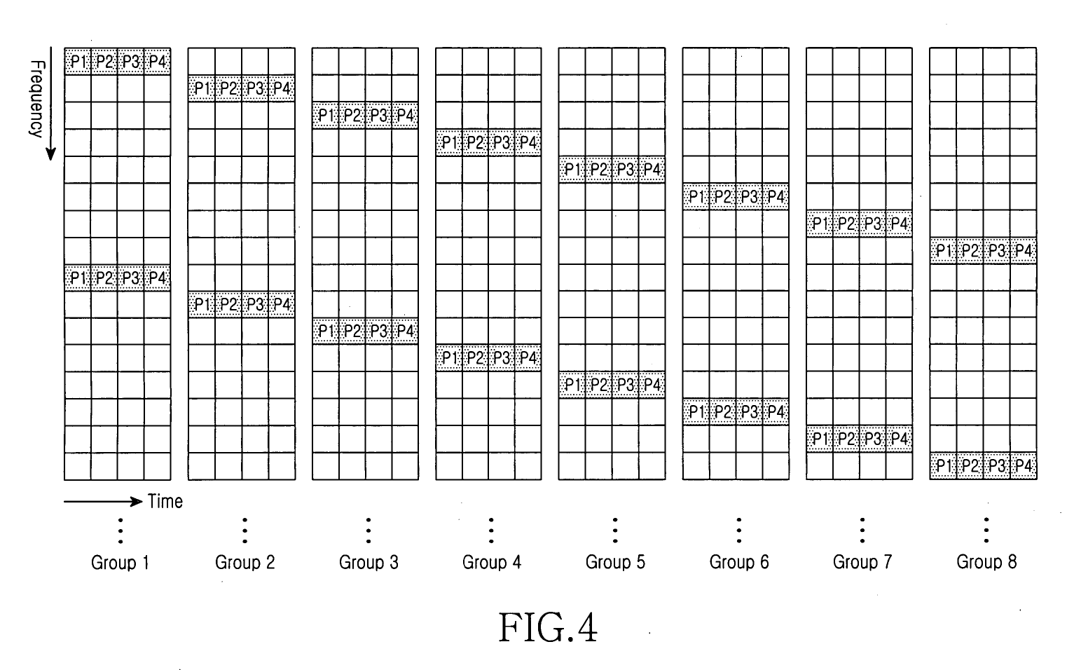

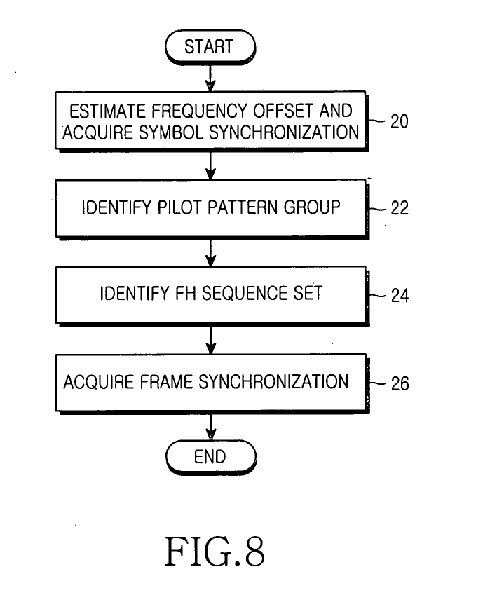

FIG. 4 illustrates an embodiment of the design of pilot pattern groups according to the present invention. Eight pilot pattern groups (Group 1-Group 8) having different frequency offsets are presented. As illustrated in FIG. 8, BSs transmit pilot samples on assigned sub-carriers, which are not changed over time, and data samples on the remaining sub-carriers by FH according to a corresponding FH sequence set.

Although there is no interference between pilots and data in a cell, if all cells transmit pilot samples on sub-carriers in the same positions, interference from neighbor cells increases for the pilots. Therefore, the N_{PG} pilot pattern groups having different frequency offsets are reused.

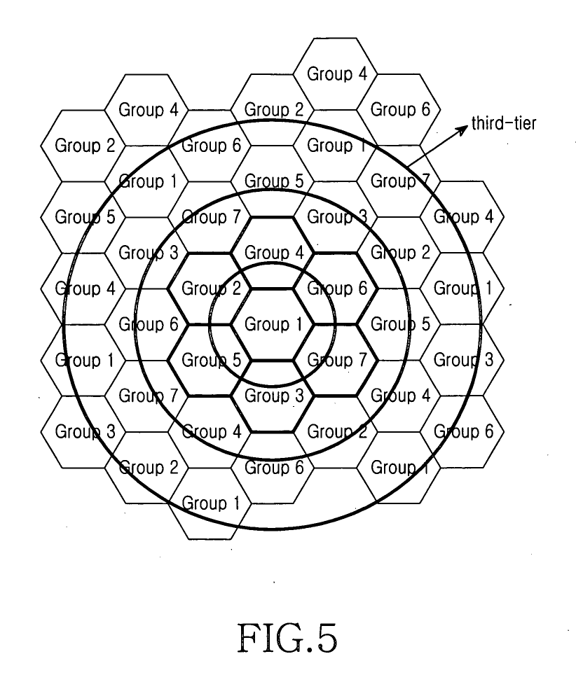

FIG. 5 illustrates an embodiment of reuse of pilot pattern groups according to the present invention. In the illustrated case, seven pilot pattern groups (Group 1-Group 7) are reused.

Referring to FIG. 5, the nearest cell that transmits pilots using the same sub-carriers exists in a third tier. Accordingly, the effects of pilot interference from neighbor cells are greatly reduced. Further, because each cell utilizes pilot sub-carriers of its neighbor cells for FH of data transmission, the probability of interference from the neighbor cells in the sub-carriers decreases. Therefore, the interference averaging effect by FH is still achieved.

If one pilot sub-carrier is assigned every M sub-carrier, a ((p−1)M+m)^{th} pilot is assigned to an m^{th} pilot pattern group. p is a natural number between 1 and N_{P}. As defined earlier, N_{P} is the number of pilot sub-carriers.

In the present invention, for N_{P} pilot sub-carriers, N_{PP} pilot patterns of length N_{P} are determined and N_{PP} BSs using the same pilot pattern group use different pilot patterns, such that the BSs can be distinguished from one another. For channel estimation, pilot samples on assigned pilot sub-carriers must be known already to a receiver. The pilot patterns are set so that a pilot detection probability can be maximized over all pilot sub-carriers with respect to a maximum variation rate of channels and the number of the pilot patterns in the system.

In a preferred embodiment of the present invention, a BS transmits 1's on all N_{P} pilot sub-carriers in an odd symbol time and a codeword having the largest minimum Hamming distance among (N_{P}, log₂N_{PP}) binary block codes in an even symbol time. When N_{PP} is a power of 2, the columns of a Hadamard matrix of size N_{PP} are transmitted in the odd symbol time.

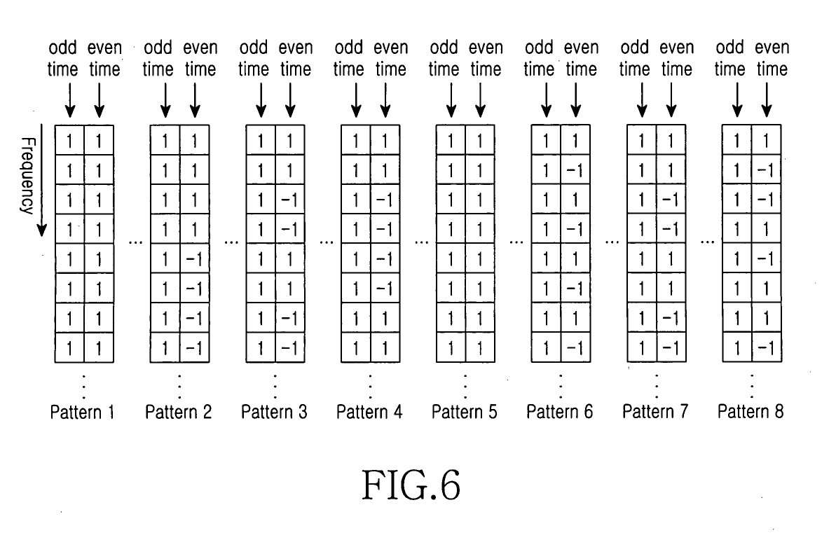

FIG. 6 illustrates an embodiment of a pilot pattern design using Hadamard sequences according to the present invention. In the illustrated case, eight pilot patterns (Pattern 1-Pattern 8) are given for eight pilot sub-carriers.

Referring to FIG. 6, eight 1s, i.e., “1,1,1,1,1,1,1,1”, are transmitted on the eight pilot sub-carriers in each odd symbol time, and a predetermined pilot pattern is transmitted on the right pilot sub-carriers in each even symbol number. For example, the FH sequences of pilot pattern 2 and pilot pattern 4 for the even symbol time are “1,1,1,1,−1,−1,−1,−1” and “1,1,−1,−1,−1,−1,1,1”, respectively. Each pilot pattern has different values for four pilot sub-carriers.

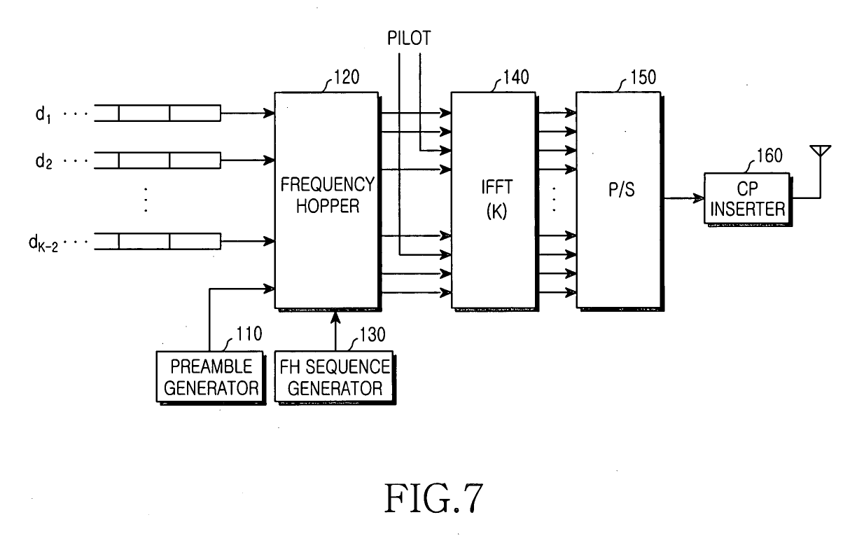

FIG. 7 is a block diagram of a BS transmitter in an FH-OFDM system to which the present invention is applied. Referring to FIG. 7, a frequency hopper 120 receives a preamble including known (K-2) samples from a preamble generator 110, or (K-2) data samples. The preamble is selected at a start point of an OFDM frame and the data samples are selected at the other time points. The frequency hopper 120 assigns the (K-2) samples to data sub-carriers according to a predetermined FH sequence received from an FH sequence generator 130.

An inverse-fast-Fourier transformer (IFFT) 140 inverse-fast-Fourier transforms the data samples assigned to the data sub-carriers and pilot samples assigned to pilot sub-carriers according to the FH sequence, thereby generating an OFDM symbol. The pilot samples, which form a pilot sequence based on a pilot pattern set for the BS, are transmitted on the pilot sub-carriers according to a pilot pattern group for the BS.

A parallel-to-serial converter (P/S) 140 serially converts the OFDM symbol. A CP inserter 160 inserts a CP as a guard interval before the serial OFDM symbol. N_{frame} OFDM symbols including CPs form an OFDM frame. Although not shown, the OFDM frame is transmitted by an antenna through a digital-to-analog converter (DAC) and an RF (Radio Frequency) module.

As described above, the BS transmits a pilot sequence corresponding to a predetermined pilot pattern in a pilot pattern group set for the BS on sub-carriers corresponding to the pilot pattern group. The positions and information of the pilots are different in each pilot pattern and an MS indirectly estimates the pilot pattern by estimating the pilot positions and information.

FIG. 8 is a flowchart illustrating an operation in an MS for acquiring initial synchronization to a BS according to the preferred embodiment of the present invention. Referring to FIG. 8, upon receiving OFDM symbols from the BS, the MS estimates a frequency offset and acquires symbol synchronization by utilizing the cyclicity of CPs inserted between OFDM symbols in step 20. Because the frequency offset estimation and the symbol synchronization acquisition are beyond the scope of the present invention, their description will not provided herein.

In step 22, the MS identifies a pilot pattern group to which the BS belongs, by detecting the positions of pilot samples in the OFDM symbols. The MS identifies a pilot pattern set for the BS and an FH sequence set corresponding to the pilot pattern by detecting a pilot sequence equivalent to the pilot samples in step 24. The FH sequence set is used by the MS to receive data from the BS. The MS then acquires frame synchronization on a symbol basis by determining whether OFDM symbols, not including the pilot samples, match a known preamble.

Step 22 illustrated in FIG. 8 is a process for estimating a most probable pilot pattern group from N_{PG} possible offsets. As illustrated in FIG. 4, because pilot sub-carriers deliver a pilot pattern sequence all the time, they have a relatively high average power compared to other sub-carriers that deliver signals intermittently. Therefore, a pilot pattern group is identified by comparing the sums of the received powers of pilot sub-carriers in all pilot pattern groups and estimating a pilot pattern group having the largest sum as the pilot pattern group.

In Equation (1), Yₖ(i) denotes a frequency-domain received signal on a k^{th} sub-carrier in an i^{th} symbol time, and an estimated index n_{PG} of the pilot pattern group is calculated by

$${n}_{PG} = arg {max}_{m} {\sum }_{i = 1}^{{N}_{S}} {\sum }_{p = 1}^{{N}_{P}} {\vert {Y}_{( p - 1 ) M + m} ( i ) \vert}^{2} , m ∈ \{ 1 , 2 , … {N}_{PG} \} \qquad ( 1 )$$

where Nₛ is the number of OFDM symbols used for estimation of the pilot pattern group and the pilot pattern, N_{P} is the number of pilot sub-carriers, and M is the number of the pilot pattern groups. arg maxₘ(·) represents a function of outputting m that maximizes the objective formula.

The pilot pattern detection in step 24 follows the estimation of the pilot pattern group. If the pilot pattern is estimated using Nₛ OFDM symbols and an 1^{th} pilot pattern of size N_{P}×Nₛ is represented in a matrix D₁, a conditional probability density function for an N_{P}×Nₛ matrix Y having Yₖ(i) as a (k, i)^{th} element is expressed as in Equation (2),

$${f}_{l} ( Y ; {D}_{l} ) = \frac{1}{{( 2 {πσ}^{2} )}^{{N}_{P} {N}_{S}}} exp [ - \frac{1}{2 {σ}^{2}} {\sum }_{i = 1}^{{N}_{S}} {\sum }_{p = 1}^{{N}_{P}} {\vert {Y}_{p} ( i ) - {h}_{p} ( i ) {d}_{lp} ( i ) \vert}^{2} ] \qquad ( 2 )$$

where h_{P}(i) is a channel coefficient for a p^{th} pilot sub-carrier in the i^{th} symbol time and dₗₖ(i) is a pilot sample transmitted on the k^{th} pilot sub-carrier being the (k, i)^{th} element of Dₗ in the i^{th} symbol time. The MS, which cannot know the channel coefficient accurately, obtains a pilot pattern estimate that maximizes an extended conditional probability density function with h′ₗₚ(i) substituted for h_{P}(i), h′ₗₚ(i) being computed under the assumption that Dₗ is transmitted. This extended conditional probability density function is expressed in Equation (3) below.

$${f}_{l} ( Y ; {H}_{l ,} {D}_{l} ) = \frac{1}{{( 2 {πσ}^{2} )}^{{N}_{p} {N}_{s}}} exp [ - \frac{1}{2 {σ}^{2}} {\sum }_{i = 1}^{{N}_{S}} {\sum }_{p = 1}^{{N}_{P}} {\vert {Y}_{p} ( i ) - {{h}^{′}}_{p} ( i ) {d}_{lp} ( i ) \vert}^{2} ] \qquad ( 3 )$$

With respect to only items associated with the transmitted pilot pattern, Equation (3) is developed as in Equation (4).

$${J}_{l} = {\sum }_{i = 1}^{{N}_{S}} {\sum }_{p = 1}^{{N}_{P}} {Y}_{p} ( i ) {h}_{lp}^{′ *} ( i ) {d}_{lp}^{*} ( i ) \qquad ( 4 )$$

Then, the estimated pilot pattern, n_{PP} is shown in Equation (5).

$${n}_{PP} = arg {max}_{l} {\sum }_{i = 1}^{{N}_{S}} {\sum }_{p = 1}^{{N}_{P}} {Y}_{p} ( i ) {h}_{lp}^{′ *} ( i ) {d}_{lp}^{*} ( i ) , l ∈ \{ 1 , 2 , … {N}_{PP} \} \qquad ( 5 )$$

Because the channel estimate h′ₗₚ is included in the objective formula, the objective formula varies depending on how the channel is estimated. In turn, the pilot pattern maximizing the pilot pattern detection probability is also changed. An optimum channel estimate value is obtained by averaging as many instantaneous channel estimates as possible in a period for which the channel is not changing. Therefore, the change of the objective formula according to a channel variation rate and a design of optimum pilot patterns in each case will be described briefly.

Assuming that channel characteristics change every OFDM symbol, the channel estimate h′ₗₚ(i) is calculated by Equation (6) below.
h′ₗₚ(i)=dₗₚ*(i)Y_{P}(i) (6)

By substituting Equation (6) into Equation (4), Equation (7) is obtained.

$${J}_{l} = {\sum }_{i = 1}^{{N}_{S}} {\sum }_{p = 1}^{{N}_{P}} {\vert {Y}_{p} ( i ) \vert}^{2} {\vert {d}_{lp} ( i ) \}}^{2} \qquad ( 7 )$$

If dₗₚ(i) has a certain energy, irrespective of the type of the pilot pattern, the objective formula of Equation (7) leads to a value irrespective of the pilot pattern. Consequently, the pilot pattern detection is impossible. Accordingly, the channel characteristics must be unchanged for at least two OFDM symbol periods in order to distinguish pilot patterns. Under the preposition that channel characteristics are unchanged for two OFDM symbol periods, h′ₗₚ(i) is determined by Equation (8) below.

$${h}_{lp}^{′} ( i ) = \frac{1}{2} \{ {d}_{lp}^{*} ( i ) {Y}_{p} ( i ) + {d}_{lp}^{*} ( i - 1 ) {Y}_{p} ( i - 1 ) \} \qquad ( 8 )$$

Because Equation (8) results in a maximum likelihood channel estimate, substituting of Equation (8) into Equation (5), and eliminating terms unrelated to pilot pattern types, results in a final pilot pattern determining equation expressed as in Equation (9),

$${n}_{PP} = arg {max}_{l} {\sum }_{i = 2}^{{N}_{S}} {\sum }_{p = 1}^{{N}_{P}} {Y}_{p} ( i ) {Y}_{p}^{*} ( i - 1 ) {d}_{lp}^{*} ( i ) {d}_{lp} ( i - 1 ) , \\ l ∈ \{ 1 , 2 , … {N}_{PP} \} \qquad ( 9 )$$

which presupposes that channel characteristics are unchanged for two OFDM symbol periods.

The pilot patterns illustrated in FIG. 6 are designed such that the difference between decision values is maximized, one decision value being derived when the above presupposition is right and the other decision value being derived when the presupposition is wrong. For each sub-carrier, when a combination of dₗₚ(i) and dₗₚ(i-1) is (1, −1) or (−1, 1) and a combination of d_{l′p}(i) and d_{l′p}(i-1) is (1, 1), the average value of an objective formula in the former case is 1 and the value of the objective formula in the latter case is −1. Thus, the difference between the values is maximal. The objective formula is
Y_{P}(i)Y_{P}*(i−1)dₗₚ*(i)dₗₚ(i−1) in Equation (9).

Under the presupposition that the maximum channel variation rate of a system is low and channel characteristics are fixed for F OFDM symbol periods, the maximum likelihood channel estimate is computed by Equation (10) below.

$${h}_{lp}^{′} ( i ) = \frac{1}{F} {\sum }_{k = 0}^{F - 1} {d}_{lp}^{*} ( i - k ) {Y}_{p} ( i - k ) \qquad ( 10 )$$

In this case, a pilot pattern determining formula is given as in Equation (11).

$${n}_{PP} = arg {max}_{l} {\sum }_{i = 2}^{{N}_{S}} {\sum }_{p = 1}^{{N}_{P}} {\sum }_{k = 0}^{F - 1} {Y}_{p} ( i ) {Y}_{p}^{*} ( i - k ) {d}_{lp}^{*} ( i ) {d}_{lp} ( i - k ) , \\ l ∈ \{ 1 , 2 , … {N}_{pp} \} \qquad ( 11 )$$

Similarly, the difference between decision values is maximized, one decision value being derived when the above presupposition is right and the other decision value being derived when the presupposition is wrong.

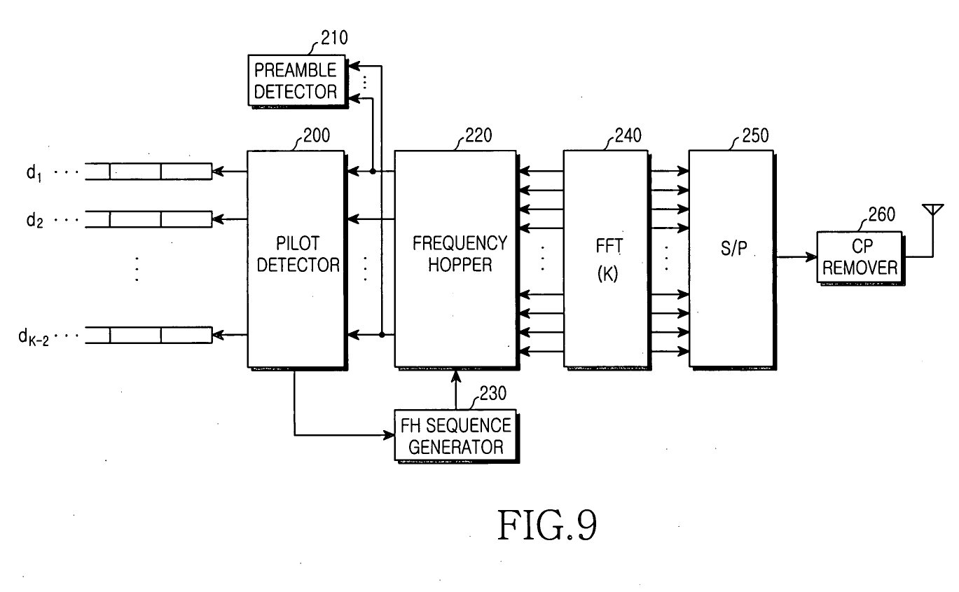

FIG. 9 is a block diagram of an MS receiver corresponding to the transmitter illustrated in FIG. 6 in the FH-OFDM system to which the present invention is applied. Referring to FIG. 9, a time-domain OFDM frame received through an RF module and an analog to digital converter (ADC) is applied to the input of a CP remover 260. The CP remover 260 distinguishes N_{frame} OFDM symbols by removing CPs from the OFDM frame. A serial-to-parallel converter (S/P) 250 converts the OFDM symbols in parallel.

A fast-Fourier-transformer (FFT) 240 fast-Fourier-transforms the OFDM symbols and outputs K samples corresponding to K sub-carriers in every OFDM symbol period. A frequency hopper 220 recovers the K samples in the original order according to a predetermined FH sequence received from an FH sequence generator 230.

A preamble detector 210 detects a preamble from the samples received from the frequency hopper 220 and estimates the first OFDM symbol of the OFDM frame. A pilot detector 200 detects pilot samples at particular sub-carrier positions among the K samples received from the frequency hopper 220, estimates an FH sequence used in the transmitter according to the sub-carrier positions and the pattern of the pilot samples, and provides information about the estimated FH sequence to the FH sequence generator 230. The pilot detector 200 outputs the remaining data samples except for the detected pilot samples.

By utilizing the pilot pattern groups and pilot patterns proposed in the present invention, N_{PG}×N_{PP} BSs can be distinguished. Characteristics specific to each BS can be estimated simply by estimating its pilot pattern group and pilot pattern through one-to-one matching of a combination of two parameters and a pilot pattern set used for the BS.

The slope S of the Latin square FH pattern used in the conventional technology, the pilot pattern group index n_{PG}{0, 1, . . . , N_{PG-1}}, and the pilot pattern index n_{PP}{0, 1, . . . , N_{PP-1}} are in a relationship wherein S=n_{PG}×N_{PP}+p.

Here, p is a pilot sub-carrier index between 1 and N_{P}. In other words, as many BS identifiers as available in the conventional technology can be generated in the present invention.

Accordingly, the present invention enables BS identification through estimation of n_{PG} and n_{PP} without the need for complex computation involved with direct estimation of the slope.

Acquisition of Frame Synchronization

After an MS estimates the pilot pattern of a BS, it acquires frame synchronization to receive downlink broadcast information and attempt an uplink access. The frame synchronization is acquired by detecting a preamble in the beginning of an OFDM frame (step 26 in FIG. 7).

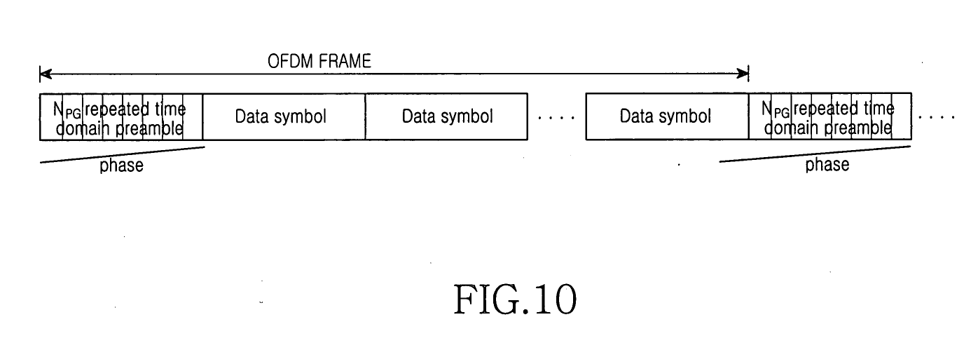

FIG. 10 illustrates an OFDM frame including a time-domain preamble according to the present invention. Referring to FIG. 10, a time-domain preamble as long as a predetermined number of OFDM symbols are positioned in the beginning of an OFDM frame. In the illustrated case, the preamble is one OFDM symbol long. The preamble varies according to a pilot pattern group. An MS receiver estimates the start point of the frame by correlating a received signal with a preamble corresponding to the estimated pilot pattern group at the start point of each OFDM symbol and by comparing the correlation with a reference value.

Referring to FIGS. 6 and 9, the preamble generator 110 in the BS periodically inserts a time-domain preamble as long as one OFDM symbol in each OFDM frame. Given N_{PG} pilot pattern groups, the preamble is created by repeating a predetermined real-number sequence N_{PG} times in the time domain. As a result, only ((p−1)M+1)^{th} sub-carriers (p=1, 2, . . . , N_{P}) in the frequency domain have energy. Here, M is a minimum interval between pilot sub-carriers and the sequence is a training sequence of length N/N_{PG} preset between the BS and the MS. An offset can be shifted to an (M(p−1)+m)^{th} sub-carrier position (p=1, 2, . . . , N_{P}) for an m^{th} pilot pattern group (m=1, 2, . . . , N_{PG}) by multiplying an n^{th} sample among N samples of the time-domain preamble by e^{j2πmn/N}. The preamble detector 210 in the MS correlates the preamble corresponding to the estimated pilot pattern group with a multi-path signal received for W samples having the start point of an OFDM symbol at a center, for each OFDM symbol, and selects an OFDM symbol having the highest correlation among N_{frame} OFDM symbols. The position of the selected OFDM symbol is an estimated start point of the frame.

Different preambles are used for different pilot pattern groups for the following reasons.

(1) If a time-domain preamble is created in a conventional manner, energy exists over the entire frequency band, resulting in interference to all sub-carriers of a neighbor cell when the preamble is transmitted. To overcome this problem, the preamble of the present invention has controlled frequency responses according to a pilot pattern group for a BS such that energy exists only on pilot sub-carriers for the BS and thus inter-cell interference is minimized.

(2) Handoff is facilitated. For a handoff, an MS continuously monitors signals from neighbor BSs and estimates their characteristics. If each pilot pattern group uses a different preamble, the MS can estimate a pilot pattern group to which a target BS belongs using the correlation of a pre-FFT time-domain signal with the preamble.

When pilot pattern groups are designed appropriately, there may be only one BS that has the estimated pilot pattern group among BSs to which the MS can be handed off. Then, the MS can determine all neighbor BS information required for the handoff, i.e., frame synchronization information and an FH pattern, without additionally estimating a pilot pattern.

More specifically, the MS identifies the pilot pattern group using a frequency-domain signal only when two or more neighbor BSs that belong to the same pilot pattern group exist around a serving BS due to a low reuse factor of pilot pattern groups. This eliminates the need for computation using a post-FFT signal as in the conventional technology. As a result, the period is shortened in which ongoing communication is interrupted for searching signals from neighbor cells.

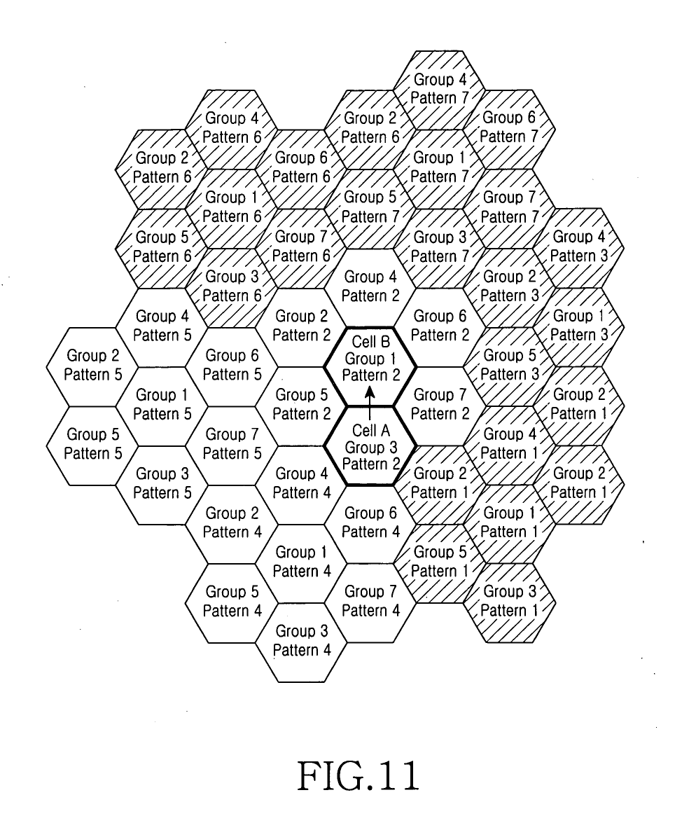

FIG. 11 illustrates an embodiment of assignment of pilot pattern groups and pilot patterns according to the present invention. As illustrated in FIG. 11, each BS and its neighbor BSs use the same pilot pattern in different pilot pattern groups, on the whole.

For example, an MS communicating within cell A moves to a new cell and determines that the index of a pilot pattern group for the new cell is 1, using a time-domain pilot signal from the new cell. Because only cell B uses the pilot pattern group of index 1 among cells neighboring to cell A, the MS determines that the new cell is cell B. The pilot pattern of cell B is identical to that of cell A and therefore, the MS can obtain information about cell B without processing of a frequency-domain signal, i.e., FFT.

More specifically, the MS in communication monitors a valid signal from a neighbor cell by a correlation based on a CP. When detecting an effective signal from the neighbor cell, the MS estimates a frequency offset and acquires symbol synchronization. The MS then acquires frame synchronization by correlating the neighbor cell signal with time-domain preambles corresponding to all possible pilot pattern groups and selecting a pilot pattern group having the largest correlation, and identifies the neighbor cell by the pilot pattern group. Therefore, the MS identifies the new cell for the handoff.

The BS identifying method of the present invention and the conventional technology using the Latin square FH sequences were simulated in terms of BS detection performance. The simulation was performed under the conditions that:
the number of sub-carriers (N)=128;
the length of a CP (N_{P})=16;
the number of pilot sub-carriers (N_{P})=16;
channel length (L)=12;
carrier frequency=2 GHs;
sampling rate=1.44 MHz;
the speed of an MS=60 km/h (10⁻³ to 10⁻¹ for normalized Doppler frequency);
the number of the elements of a Latin square FH sequence slope set (Nₛₗₒₚₑ)=127;
the number of pilot pattern groups (N_{PG})=8;
the number of pilot patterns for each group (N_{PP})=16;
FH sequence for data transmission: Latin square pattern (for both data transmission and pilot transmission in the conventional technology);
transmit data and pilots using 30 FH sequences at the same time;
the pilot symbol energy to data symbol energy ratio=2:1 (pilot symbol energy twice greater than data symbol energy); and
the number of OFDM symbols for estimation of a pilot pattern group and a pilot pattern (N_{S})=3 to 9.

Herein below, the present invention will be compared with an optimal estimation algorithm for achieving optimum performance using the Latin square FH sequence and a sub-optimal algorithm for reducing computation volume.

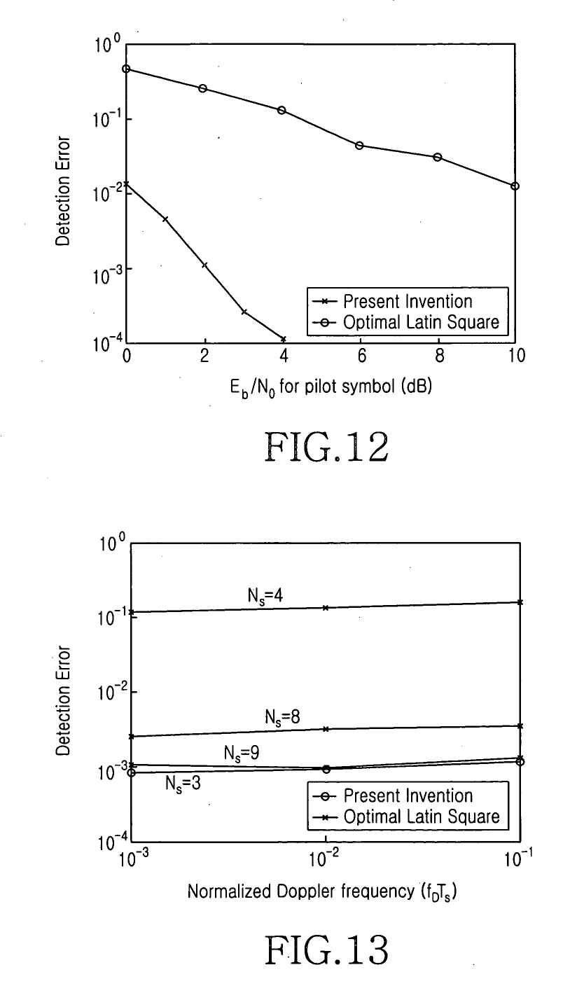

FIG. 12 is a graph comparing the present invention with a conventional optimal estimation algorithm using the Latin square FH sequence in terms of detection errors versus a bit energy to noise ratio (E_{b}/Nₒ). As noted from FIG. 12, the present invention offers a better BS detection performance than the conventional optimal estimation algorithm under the same E_{b}/Nₒ environment.

FIG. 13 is a graph comparing the present invention with the conventional optimal estimation algorithm using the Latin square FH sequences in terms of detection errors versus normalized Doppler frequency (f_{D}T_{S}) for varying N_{S} when E_{b}/Nₒ is 3 dB. Here, f_{D} is a Doppler frequency and T_{S} is a sampling period. f_{D}T_{S}=0.001, 0.01, and 0.1 are channel variations for 5.3, 53, and 530 km/h, respectively, at a carrier frequency of 2 GHz. At 5 GHz, they are channel variations for 2.15, 21.5, and 215 km/h. As illustrated in FIG. 13, to achieve a detection error rate of 10⁻³, the conventional technology needs 9 OFDM symbols, whereas only 3 OFDM symbols suffice for the present invention. Therefore, an additional gain is achieved in terms of buffer size and computation complexity in the present invention.

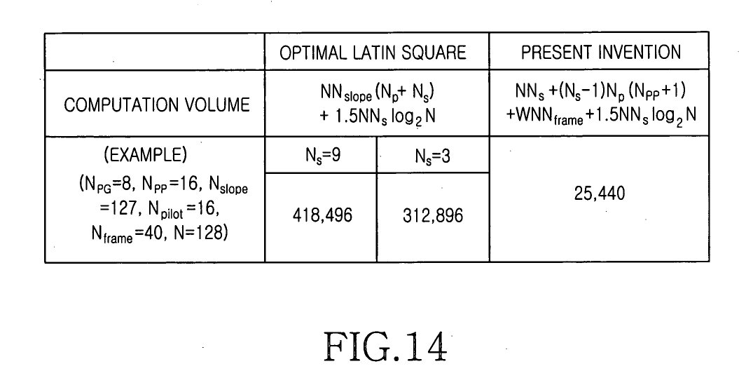

FIG. 14 is a table comparing the present invention with the conventional optimal estimation algorithm using the Latin square FH sequence in terms of computation requirements. Here, N_{frame} is the number of OFDM symbols that form one OFDM frame, Nₛₗₒₚₑ is the number of the elements of an FH pattern slope set, and N is the total number of sub-carriers. As illustrated in FIG. 14, as more OFDM symbols are used to reduce a detection error rate, a computation requirement significantly increased in the conventional technology. However, the present invention needs much less computation volume.

By combining a pilot pattern group and a pilot pattern, a BS is identified more rapidly and with a less computations. Also, sufficient BS identification information can be achieved with the reduced computations. The use of a time-domain preamble for frame synchronization enables an MS to achieve synchronization information about a neighbor BS easily in a handoff without interrupting the ongoing communication with a serving BS.

While the present invention has been shown and described with reference to certain preferred embodiments thereof, it will be understood by those skilled in the art that various changes in form and details may be made therein without departing from the scope of the present invention as defined by the appended claims.

1. A communication method in a frequency hopping-orthogonal frequency division multiplexing (FH-OFDM) communication system including a plurality of base stations (BSs), comprising the steps of:
generating a predetermined number of pilot pattern groups, each having a predetermined number of different pilot patterns for pilot transmission;
mapping the pilot patterns in each of the pilot pattern groups to different FH sequence sets; and
assigning the pilot patterns and the FH sequence sets to the BSs so that mobile stations (MSs) within service areas of the plurality of BSs can identify the BSs.

2. The communication method of claim 1, wherein the step of generating the predetermined number of the pilot pattern groups comprises the step of assigning pilots to ((p−1)M+m)^{th} sub-carriers for an m^{th} pilot pattern group, p being a natural number increasing to N_{P}, starting from 1, and N_{P} being a number of sub-carriers to which pilots are assigned.

3. The communication method of claim 1, wherein the step of mapping the pilot patterns comprises the step of mapping the pilot patterns such that each of the pilot patterns is a sequence of all 1's in every odd symbol time and is a codeword having a largest minimum Hamming distance among (N_{P}, log₂N_{PP}) binary block codes in every even symbol time.

4. The communication method of claim 1, wherein the step of mapping the pilot patterns comprises the step of mapping the pilot patterns such that each of the pilot patterns is a sequence of all 1's in every odd symbol time and is a Hadamard sequence as long as a number of the pilot patterns included in each of the pilot pattern groups in every even symbol time.

5. The communication method of claim 1, wherein the step of assigning the pilot patterns and the FH sequence sets to the BSs comprises the step of assigning the pilot patterns so that neighbor BSs have pilot patterns in different pilot pattern groups.

6. The communication method of claim 1, wherein the step of assigning the pilot patterns and the FH sequence sets to the BSs comprises the step of assigning the pilot patterns so that neighbor BSs have a same pilot pattern.

7. The communication method of claim 1, further comprising the step of transmitting from each of the BSs a pilot sequence corresponding to a pilot pattern assigned to the BS on sub-carriers corresponding to a pilot pattern group assigned to the BS.

8. The communication method of claim 1, further comprising the steps of:
generating a time-domain preamble from each of the BSs so that energy exists only on sub-carriers corresponding to the pilot pattern group assigned to the BS; and
transmitting from the BS the preamble at a start point of each frame.

9. The communication method of claim 8, wherein the step of generating the time-domain preamble comprises the step of repeating a predetermined real-number sequence as many times as a number of the pilot pattern groups and multiplying an n^{th} sample among N samples of the time-domain preamble by e^{j2πmn/N}, where m is an index of the pilot pattern group assigned to the BS, N is a number of the samples, and n is a sample index (n=1,2, . . . N).

10. An access method in a mobile station (MS) in a frequency hopping-orthogonal frequency division multiplexing (FH-OFDM) communication system including a plurality of base stations (BSs), comprising the steps of:
receiving a plurality of symbols from a BS, each having pilot samples;
detecting sub-carriers that deliver the pilot samples in each of the symbols;
identifying a pilot pattern group corresponding to the pilot sub-carriers;
detecting a pattern of the pilot samples; and
estimating an FH sequence set corresponding to the pilot pattern to receive data from the BS.

11. The access method of claim 10, wherein the step of identifying a pilot pattern group corresponding to the pilot sub-carriers comprises the step of detecting a pilot pattern group having sub-carriers of a highest average power among all available pilot pattern groups.

12. The access method of claim 10, wherein the step of identifying the pilot pattern group is performed by
$${n}_{PG} = arg {max}_{m} {\sum }_{i = 1}^{{N}_{S}} {\sum }_{p = 1}^{{N}_{P}} {\vert {Y}_{( p - 1 ) M + m} ( i ) \vert}^{2} , m ∈ \{ 1 , 2 , … {N}_{PG} \}$$
where n_{PG} is an index of an identified pilot pattern group, N_{S} is a number of symbols used to estimate the FH sequence set, N_{P} is a number of the pilot sub-carriers, Yₖ(i) is a frequency-domain signal received on a k^{th} sub-carrier in an i^{th} symbol time, M is a minimum interval between the pilot sub-carriers, and N_{PG} is a number of the pilot pattern groups.

13. The access method of claim 10, wherein the step of identifying the pilot pattern group is performed by
$${n}_{PP} = arg {max}_{l} {\sum }_{i = 2}^{{N}_{S}} {\sum }_{p = 1}^{{N}_{P}} {\sum }_{k = 0}^{F - 1} {Y}_{p} ( i ) {Y}_{p}^{*} ( i - k ) {d}_{lp}^{*} ( i ) {d}_{lp} ( i - k ) , l ∈ \{ 1 , 2 , … , {N}_{pp} \}$$
where n_{PP} is an index of an identified pilot pattern group, F is a number of symbols unchanged in channel characteristics, N_{S} is a number of symbols used to estimate the FH sequence set, N_{P} is a number of the pilot sub-carriers, Yₖ(i) is a frequency-domain signal received on a k^{th} pilot sub-carrier in an i^{th} symbol time, dₗₖ(i) is a pilot sample transmitted on the k^{th} pilot sub-carrier in an i^{th} symbol time, and N_{PP} is a number of the pilot patterns included in each of the pilot pattern groups.

14. The access method of claim 10, further comprising the step of correlating a preamble corresponding to the identified pilot pattern group with a predetermined number of multi-path signals for each of the plurality of symbols and determining a symbol having a largest correlation as a start point of a frame.

15. The access method of claim 10, further comprising the step of recovering data samples included in the symbols in an original order according to the FH sequence set.

16. The access method of claim 10, further comprising the steps of:
detecting a valid signal from a neighbor BS;
correlating the valid signal with all available pilot pattern groups;
detecting a pilot pattern group having a largest correlation; and
determining that the neighbor BS has the identified pilot pattern group and the identified pilot pattern.
